(19) United States
(12) Patent Application Publication
(10) Pub. No.: US 2005/0036059 A1
(43) Pub. Date: Feb. 17, 2005

(54) Ingestible imaging system

(76) Inventor: Benad Goldwasser, Tel Aviv (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/639,444

(22) Filed: Aug. 13, 2003

(51) Int. Cl. H04N 5/225; H04N 7/18; H04N 9/47

(52) U.S. Cl. 348/373; 348/77

(57) ABSTRACT

An ingestible imaging system including an ingestible housing including an imaging sensor and a motor-driven propulsion device.

### FIELD OF THE INVENTION

The present invention relates generally to imaging systems for the gastrointestinal (GI) tract, and particularly to an ingestible imaging system with a propulsion device.

### BACKGROUND OF THE INVENTION

Swallowable electronic capsules are known which collect data and transmit the data to a receiver system. These intestinal capsules, which are moved through the digestive system through the action of digestion, are often called “Heidelberg” capsules and are utilized to measure pH, temperature and pressure throughout the intestines. They have also been utilized to measure gastric residence time, which is the time it takes for food to pass through the stomach and intestines.

U.S. Pat. No. 5,604,531 to Iddan et al. describes an in vivo video camera system and an autonomous video endoscope. The system includes a swallowable capsule, a transmitter and a reception system. The swallowable capsule includes a camera system and an optical system for imaging an area of interest onto the camera system. The transmitter transmits the video output of the camera system and the reception system receives the transmitted video output.

U.S. Pat. No. 6,527,705 to Ouchi describes a fully swallowable endoscopic system. The system includes a rod-shaped endoscope body which can be swallowed entirely by a patient to be examined so as to be placed in a body cavity. The rod-shaped endoscope body includes two bendable portions respectively provided close to the opposite ends of the rod-shaped endoscope body and each being bendable along a curve of the body cavity. An external device is provided separately from the rod-shaped endoscope body having no mechanical connection with the rod-shaped endoscope body. The rod-shaped endoscope body is provided with at least one light emitter, at least one observing system, a transmitter for transmitting a radio wave which carries an image formed by the observing system, and a power supply. The external device includes a receiver for receiving the radio wave which carries the image.

### SUMMARY OF THE INVENTION

The present invention seeks to provide an improved an ingestible imaging system with a propulsion device, as is described in detail hereinbelow.

There is thus provided in accordance with an embodiment of the present invention an ingestible imaging system comprising an ingestible housing comprising an imaging sensor and a motor-driven propulsion device.
in accordance with an embodiment of the present invention the motor-driven propulsion device comprises a motor and a propeller.

Further in accordance with an embodiment of the present invention the ingestible housing further comprises a steering device. The motor-driven propulsion device may propel the ingestible housing in a random motion or controlled path.

Still further in accordance with an embodiment of the present invention a processor is in communication with and controls operation of the motor-driven propulsion device, the steering device and/or the imaging sensor. The processor may be internal or external to the ingestible housing.

In accordance with an embodiment of the present invention the ingestible housing further comprises a transmitter and/or a receiver.

Further in accordance with an embodiment of the present invention a guard is provided that prevents the motor-driven propulsion device from contacting tissue.

Still further in accordance with an embodiment of the present invention the imaging sensor comprises a CCD camera, an illumination device, a vision device, an ultrasound sensor, and/or an x-ray emitter.

In accordance with an embodiment of the present invention the ingestible housing comprises a magnetic device.

### BRIEF DESCRIPTION OF THE DRAWINGS

The present invention will be understood and appreciated more fully from the following detailed description taken in conjunction with the appended drawings in which:

FIG. 1 is a simplified pictorial illustration of an ingestible imaging system, in accordance with an embodiment of the present invention;

FIG. 2 is a simplified block diagram of the ingestible imaging system of FIG. 1, in accordance with an embodiment of the present invention; and

FIG. 3 is a simplified illustration of the ingestible imaging system of FIG. 1 moving inside a stomach, in accordance with an embodiment of the present invention.

### DETAILED DESCRIPTION OF PREFERRED EMBODIMENTS

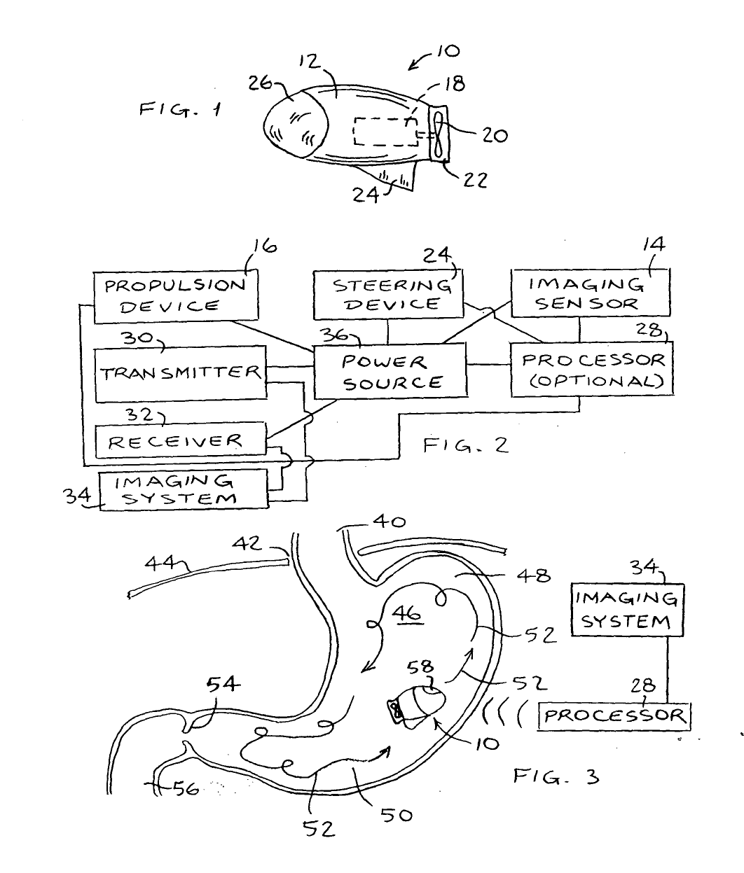

Reference is now made to FIGS. 1 and 2, which illustrate an ingestible imaging system 10, constructed and operative in accordance with an embodiment of the present invention.

The ingestible imaging system 10 may comprise an ingestible housing 12, made of any suitable material for ingestion into the GI tract. Ingestible housing 12 may comprise an imaging sensor 14 and a motor-driven propulsion device 16.

The motor-driven propulsion device 16 may comprise a motor 18 and a propeller 20. A guard 22 may be provided near or around propeller 20 to prevent propulsion device 16 from contacting tissue. A steering device 24, such as but not limited to, a rudder, may be provided to steer ingestible imaging system 10. Steering device 24 may protrude from ingestible imaging system 10 or may be retracted into ingestible imaging system 10. Steering device 24 may be at any position on ingestible imaging system 10 (e.g., rear, front, sides, top, bottom, etc.) The steering device 24 may be positioned near propeller 20 to serve as the guard 22, for example.

Imaging sensor 14 may comprise, without limitation, a CCD camera, an illumination device, a vision device, an ultrasound sensor, and/or an x-ray emitter. For optical imaging devices, housing 12 may comprise a transparent window 26 for providing imaging sensor 14 with a better field of view.

A processor 28 may be provided, which communicates with and controls operation of motor-driven propulsion device 16 and/or steering device 24. Processor 28 (also referred to as a “controller”) may be internal to housing 12. Alternatively or additionally, processor 28 may be external to housing 12, and may communicate with the components of gastrointestinal apparatus 10, such as by means of wired or wireless communication (e.g., RF or IR communication, BLUETOOTH), as seen in FIG. 3.

Ingestible housing 12 may further comprise a transmitter 30 and/or a receiver 32, for transmitting data from imaging sensor 14 to an image processing system 34, which processes the images captured by imaging sensor 14. The receiver 32 may be used to receive data or commands from image processing system 34 or processor 28. Processor 28 may be part of image processing system 34, and may also be in communication with imaging sensor 14. A power source 36 may be incorporated in housing 12 for powering the components of ingestible imaging system 10.

Reference is now made to FIG. 3, which illustrates ingestible imaging system 10 moving inside a stomach, in accordance with an embodiment of the present invention.

In operation, a patient may drink a certain quantity of liquid (such as but not limited to, 1 liter of water) to stretch the stomach wall for better image capturing and for providing a better “marine environment” for ingestible imaging system 10 to “cruise” around the inside of the stomach.

After swallowing ingestible imaging system 10, the housing 12 moves down the esophagus 40 opposite the hiatus 42 of the diaphragm 44 and travels into the stomach 46. Images of the esophagus 40 may be captured by imaging sensor 14. The motor-driven propulsion device 16 may be switched on at any time. For example, processor 28 may be programmed to initiate operation of motor-driven propulsion device 16 after a predetermined time. The motor-driven propulsion device 16 may propel housing 12 in a random motion path, wherein the ingestible imaging system 10 randomly cruises the inner volume of the stomach, while capturing images of any of the stomach structures, such as but not limited to, the fundus 48 and antrum 50, as indicated by arrows 52. Alternatively, processor 28 may control movement, direction, velocity and acceleration of the ingestible imaging system 10 as desired.

The motor-driven propulsion device 16 may be switched off at a random or predetermined time. The ingestible imaging system 10 may then follow the GI tract from the stomach, passing through the pylorus 54 into the duodenum 56, and from there to the rest of the small intestine. In accordance with an embodiment of the present invention, ingestible housing 12 may comprise a magnetic device 58. After the ingestible imaging system 10 has moved through the small intestine to the cecum, a catheter or endoscopic device (not shown) with a magnet may be introduced through the large intestine and be attached to the magnetic device 58. The catheter or endoscopic device together with the ingestible imaging system 10 may then be pulled and retracted backwards out of the large intestine, all the while capturing images of the large intestine.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

1. An ingestible imaging system comprising:
an ingestible housing comprising an imaging sensor and a motor-driven propulsion device.

2. The ingestible imaging system according to claim 1, wherein said motor-driven propulsion device comprises a motor and a propeller.

3. The ingestible imaging system according to claim 1, wherein said ingestible housing further comprises a steering device.

4. The ingestible imaging system according to claim 1, wherein said motor-driven propulsion device is adapted to propel said ingestible housing in a random motion path.

5. The ingestible imaging system according to claim 3, further comprising a processor in communication with at least one of said motor-driven propulsion device and said steering device, which controls operation of at least one of said motor-driven propulsion device and said steering device.

6. The ingestible imaging system according to claim 5, wherein said processor is internal to said ingestible housing.

7. The ingestible imaging system according to claim 5, wherein said processor is external to said ingestible housing.

8. The ingestible imaging system according to claim 3, further comprising a processor in communication with said imaging sensor.

9. The ingestible imaging system according to claim 1, wherein said ingestible housing further comprises a transmitter.

10. The ingestible imaging system according to claim 1, wherein said ingestible housing further comprises a receiver.

11. The ingestible imaging system according to claim 1, further comprising a guard adapted to prevent said motor-driven propulsion device from contacting tissue.

12. The ingestible imaging system according to claim 1, wherein said imaging sensor comprises at least one of a CCD camera, an illumination device, a vision device, an ultrasound sensor, and an x-ray emitter.

13. The ingestible imaging system according to claim 1, wherein said ingestible housing comprises a magnetic device.
